(19) United States
(12) Patent Application Publication
(10) Pub. No.: US 2023/0020907 A1
(43) Pub. Date: Jan. 19, 2023

(54) COLLAGEN PET CHEWS

(71) Applicant: DD Industries, Inc., Alsip, IL (US)

(72) Inventor: Kyle Wessels, Green Garden, IL (US)

(21) Appl. No.: 17/379,354

(22) Filed: Jul. 19, 2021

(51) Int. Cl. A23K 10/26; A23K 50/42; A23K 40/30; A23K 40/20; A23K 30/20

(52) U.S. Cl. CPC A23K 10/26; A23K 50/42; A23K 40/30; A23K 40/20; A23K 30/20

(57) ABSTRACT

Collagen pet chews made of at least one piece of bovine corium and at least one piece of fish skin, the fish skin having a scaled surface that is oriented away from the piece of bovine corium, the corium and fish skin being rolled into a desired shape, preferably a cylinder, and treated with dry heat to release gelatinous adhesive in the corium and fish skin that couples the corium and fish skin. The layered dehydrated collagen pet chew having improved flavor and textural characteristics.

### BACKGROUND

Pet ownership is becoming more common and today, there are over 79 million dogs in the United States of America. To help keep pets, such as dogs, happy and healthy, owners try to satiate pets' natural desires, including the desire to chew. To satisfy chewing needs, owners often provide edible treats, like pet chews. Dog owners recognize that pet chews are important for maintaining or improving a dog's oral health.

Dental health problems are very common in dogs and similar animals. The primary source of these problems is dental plaque, a biofilm of microorganisms that attaches to surfaces of the teeth. Bacteria in plaque may cause irritated gums, tartar, and cavities. If left untreated, dogs may suffer from malodor, periodontal disease, and even tooth loss. Products that promote chewing or gnawing may address and prevent dental and periodontal disease in dogs by utilizing the chewing action to remove plaque and tarter from the tooth surface.

Pet chews are often marketed as products designed to reduce plaque and tartar buildup. These pet chews are made from a large variety of processed and natural materials. For example, many pet chews are made from rope, plastic, or rubber. There are also pet chews made from rawhide, vegetables, bones, skin, and other animal parts.

One popular type of pet chew is made from type III collagen protein. Type III collagen proteins are a component of reticular fibers, a type of fiber in connective tissue that act as a supporting mesh in soft tissues and organs. A source of type III collagen protein is the inner layer of bovine hide, referred to as the corium layer. The corium layer is highly digestible and the type III collagen protein in the corium layer helps joint health, improves the pet's skin and coat, and aids in digestion.

Pet chews made from corium are long lasting and generally considered a good option for naturally cleaning dog teeth. Corium pet chews are not palatable, however, because like many processed and natural materials they have little natural flavor, and dogs or other pets can lose interest in corium pet chews quickly. Without adequate chewing time, the animal does not receive the oral health benefits because the pet chew does not remove the plaque and tarter. Some manufactures try to increase chew time and improve palatability by basting or coating the corium pet chews in flavoring. The problem with most flavoring, however, is the addition of sugars and artificial ingredients that do not benefit the pet's health.

One natural, flavorful pet chew is fish skin. Fish skins are readily available and are relatively inexpensive because they are considered a by-product to the fish processing industry. For pets, fish skins are highly palatable and very digestible. Another benefit of fish skin is that the rough, scaled surface is excellent at scraping plaque and tarter from teeth. In addition, fish tissue, such as skin and scales, is a great source for type I collagen protein. Type I collagen protein helps support and maintain strong nails and fur. Fish skin also supplies a high level of omega 3 and 6 fatty acids that help with healthy skin and a shiny coat.

However, there are problems with fish skin pet chews. Fish skin gives off a strong fishy smell that may be offensive to pet owners. Also, fish skins are not durable. Pets can quickly eat whole fish skins and for this reason the fish skin chews fail to remove plaque and tarter and therefore do little to improve the pet's oral health. Improperly processed fish skins also pose a potential health problem. For example, if a fish skin is not adequately dried, for example, air dried or dried at a temperature below 130° degrees Fahrenheit (54.4° Celsius), it may become viscous or sticky. The viscous or sticky fish skin might become lodged in a pet's esophagus and restrict breathing. Fish skins that are dried at too a high heat, for example over 185° Fahrenheit (85° Celsius), become brittle and break off into shards. These uneaten shards of fish skin are difficult for pet owners to clean-up and therefore may be perceived by pet owners as a nuisance and a waste of money.

What is needed is a pet chew that combines the durability and the health benefits of a corium pet chew with the palatability and health benefits of fish skin pet chew. This combination is more robust and has an improved texture that increases the effectiveness of the natural plaque scraping ability. Additionally, this combination has an improved natural flavor that increases its overall palatability. Further, types I and III collagens in the combined fish skin and corium pet chew are beneficial to the health of the pets.

### SUMMARY OF THE INVENTION

The present invention is directed to an edible collagen pet chew product and method of manufacturing an edible collagen pet chew product having improved palatability and textural characteristics and increased durability. Specifically, the present invention provides a pet chew comprising beef corium and fish skin. Preferably, the corium may be wrapped in fish skin such that the inventive pet chew has improved flavor and textural characteristics in comparison to a corium pet chew or fish skin pet chew. The overall textural characteristics that are enhanced in the inventive pet chew include hardness, adhesiveness, resilience, cohesion, springiness, gumminess, chewiness, and combinations thereof. The increased durability and improved textural characteristics and palatability of the present invention is easily producible, inexpensive, and satisfies a pet's need to chew while improving its oral health.

The present invention comprises a pet chew of beef corium and fish skin in desired configurations. In one aspect of the present disclosure, the edible pet chew may be constructed by layering malleable beef corium and malleable fish skins. The stacked layers of beef corium and fish skin may then be formed into a desired shape such as a cylindrical roll of a desired length and diameter. In one embodiment, the pet chew may be rolled so that a fish skin layer forms the outer surface of the pet chew. In another embodiment, the pet chew may be rolled so that a corium layer forms the outer surface of the pet chew. One skilled in the art will appreciate that the stacked layers of corium and fish skin could be folded, pressed, or molded into other shapes depending on the desired product.

In another aspect of the present disclosure the edible pet chew may be constructed with a corium core formed by rolling a malleable piece of corium into a cylindrical shape. Malleable fish skin may then partially wrap or fully wrap and encapsulate the corium core. One skilled in the art will appreciate that the malleable piece of corium could be folded, pressed, or molded into other shapes depending on the desired product.

In another aspect of the present disclosure the edible pet chew may be constructed with a corium core formed by extrusion. The extruded corium core may be made by grinding beef corium into a desired particle size. Then the granulated beef corium may be extruded, molded, or pressed into the desired core shape. One skilled in the art will appreciate that the corium may be extruded into a sheet that is subsequently formed into a desired shape. For example, the extruded sheet can be rolled into a cylinder or folded into a square. Malleable fish skin may then partially wrap or fully wrap and encapsulate the corium core.

In another aspect of the present disclosure, the edible pet chew may be constructed by wrapping the corium with a strip or rope of fish skin. The shape and dimensions of the corium, strip or rope of fish skin, and the textural characteristics, among other features, may be selected individually or collectively to selectively change the pet chew profile.

In another aspect of the present disclosure, a method of preparing an edible pet chew is provided. Such method may include forming a pet chew in accordance with any one of the present disclosures by preparing the beef corium and fish skin, rolling the corium and fish skin into a desired shape, and drying the rolled corium and fish skin into a final shape. Another method may include preparing and molding a beef corium core, drying the core, preparing a fish skin, wrapping the fish skin around the core, molding the fish skin wrapped core, and drying the fish skin wrapped core. The step of preparing and molding the corium may be by any method known in the art, such as by injection molding, extruding, or pressing.

When chewed, the dehydrated fish skin of the inventive collagen pet chew provides a textured surface that removes plaque and tartar from the teeth and provides a taste that is pleasing to dogs. The corium core of the inventive collagen pet chew provides a resiliency that encourages chewing and adds durability. These and other objectives, features, and advantages of the present invention will become apparent from the following detailed description, the accompanying drawings, and the appended claims.

### BRIEF DESCRIPTION OF THE DRAWINGS

FIG. 1A illustrates an exemplary edible pet chew in accordance with at least one embodiment of the invention where layers of fish skin and beef corium are rolled into a cylindrical shape such that corium is exposed on the outside of the pet chew;

FIG. 1B shows a piece of corium;

FIG. 1C shows a piece of fish skin with a scale side facing up;

FIG. 1D illustrates a top view of the piece of fish skin, with the scale side facing up, oriented on top of the piece of corium;

FIG. 2 illustrates an exemplary edible pet chew in accordance with at least one embodiment of the invention where layers of fish skin and beef corium are rolled into a cylindrical shape such that fish skin is exposed on the outside of the chew;

FIG. 3 illustrates a sheet of corium that was rolled into a cylindrical shape;

FIG. 4 illustrates an exemplary edible pet chew in accordance with at least one embodiment of the invention where the corium is fully encapsulated by fish skin;

FIG. 5 illustrates an exemplary edible pet chew in accordance with at least one embodiment of the invention where the corium is partially encapsulated by fish skin;

FIG. 6 illustrates granulated corium that was formed into a cylindrical shape and dehydrated;

FIG. 7 illustrates an exemplary edible pet chew in accordance with at least one embodiment of the invention where the sheet of corium was rolled into a cylindrical core and wrapped in a fish skin rope;

FIG. 8 is a flowchart depicting a manufacturing process of an embodiment of the pet chew; and

FIG. 9 is a flowchart depicting a manufacturing process of an embodiment of the pet chew.

### DETAILED DESCRIPTION

The detailed description set forth below in connection with the appended drawings is intended as a description of the presently preferred embodiments of the invention and is not intended to represent the only forms in which the present invention may be constructed or utilized. The description sets forth the invention and the sequence of steps for constructing the invention in connection with the illustrated embodiments. It is to be understood, however, that the same or equivalent functions and sequences may be accomplished by different embodiments that are also intended to be encompassed within the spirit and scope of the invention.

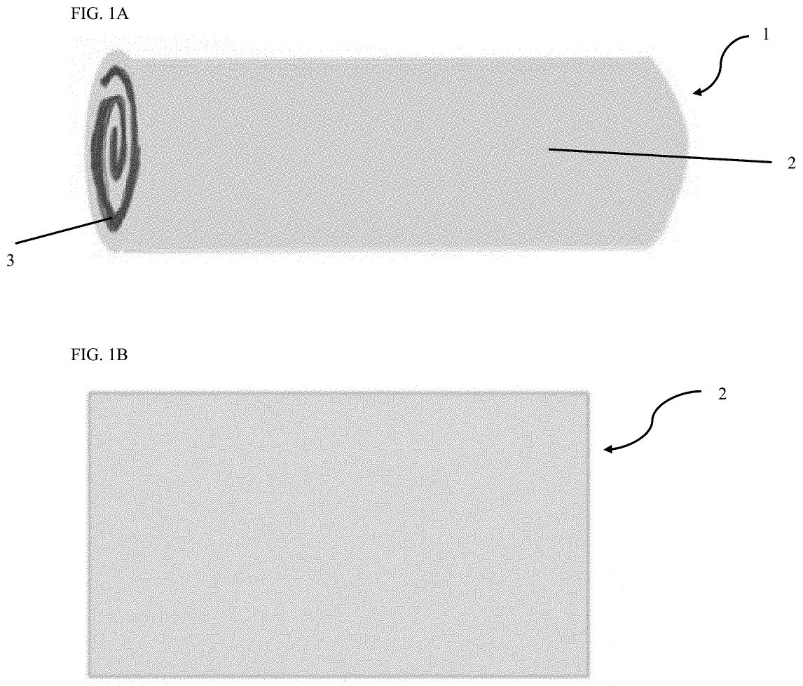

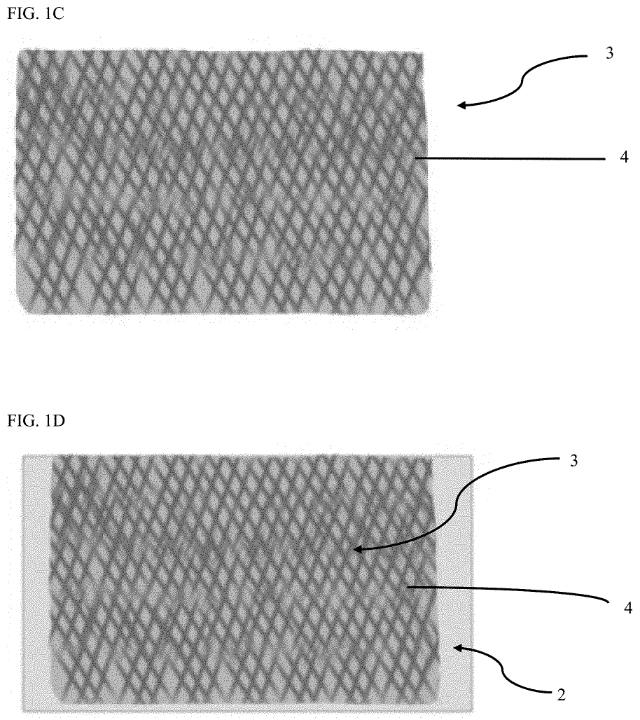

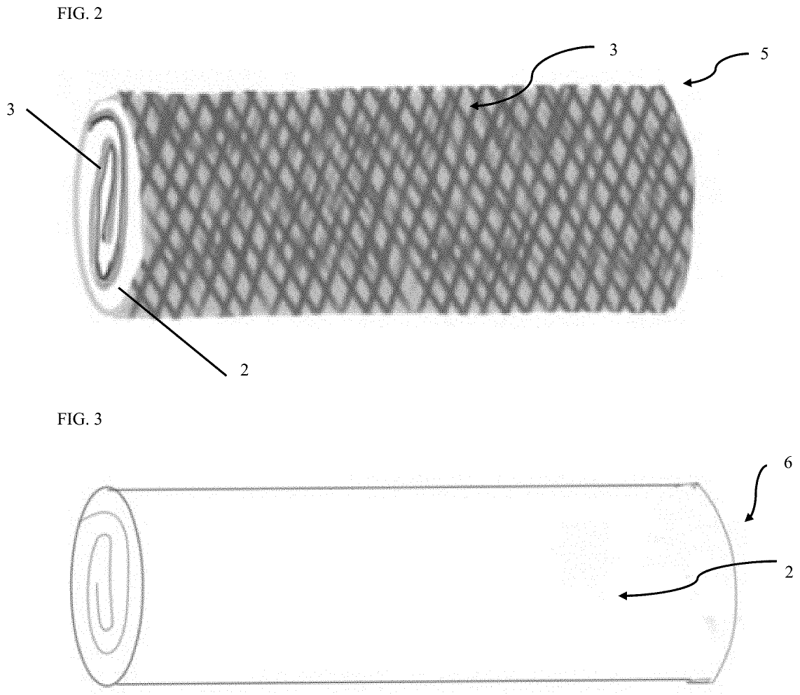

This detailed description relates to an invention for an edible collagen pet chew. Referring now to FIG. 1A, shown generally is a pet chew 1 constructed with piece of corium 2 and fish skin 3 in accordance with a preferred embodiment of the invention. As shown in FIG. 1B, a component of the illustrated pet chew 1 is a piece of corium 2. The piece of corium 2 can be fresh or preserved. Fresh corium is preferably recently separated from the epidermis, or top grain, layer of bovine skin. After the fresh corium is separated from the top grain layer it may be processed by washing with about 13% to about 15% hydrogen peroxide and about 85% to about 87% water. To facilitate the manufacturing process, the washed corium may have a moisture content preferably from about 73% to about 77%, and optimally about 75% moisture. Preserved corium is a layer of skin removed from the bovine, and then preserved by drying, salting, freezing, smoking, etc., in order to prevent deterioration. One skilled in the art will appreciate that the piece of corium 2 can be in various other stages of freshness or preservation. Regardless the stage of freshness or preservation, the piece of corium 2 retains enough moisture so that it remains malleable and the piece of corium's 2 gelatins retain adhesive properties.

Natural flavors, phytonutrients, and nutraceuticals may be added to the piece of corium 2. For example, the corium 2 may be coated in turmeric, powered pumpkin, dried coconut water, powdered avocado, or dried beet root. Alternatively, the natural flavors, phytonutrients, and nutraceuticals may be added by basting the piece of corium 2 with a liquid comprising the additives.

After the piece of corium 2 is washed in the hydrogen peroxide and water mixture, the piece of corium 2 may be cut into a desired size and shape, for example, generally about 7 inches (17.78 centimeters) long and generally about 11 inches (27.94 centimeters) wide and preferably a rectangular shape that is 8 inches (20.32 centimeters) long and 10 inches (25.4 centimeters) wide. Preferably the cut piece of corium 2 is about ⅛-inch to about ⅜-inch (3.17 to 9.5 millimeters) thick, and optimally, about ¼ inch (6.35 millimeters) thick. The piece of corium 2 may be manually cut using an utility knife, a rotary cutter, or scissors, however, automatic cutting machines can alternatively be used to cut the piece of corium 2.

As shown in FIG. 1C, another component of the inventive pet chew is fish skin 3. The fish skin 3 has a flesh side, a scaled side 4, and may have a layer of mucus or “fish slime” covering the flesh side, the scaled side 4, or both sides. The fish skin 3 may be soaked in a water bath that is between about 80° Fahrenheit and about 95° Fahrenheit (26.67° to 35° Celsius), preferably about 85° Fahrenheit (29.44° Celsius). When the fish skin 3 is between 35° Fahrenheit and 50° Fahrenheit (1.67° to 10° Celsius), preferably about 45° Fahrenheit (7.22° Celsius) it may be removed from the water bath. Soaking the fish skin 3 in the water bath may bring the fish skin 3 to the desired temperature, remove the layer of fish slime, and make the fish skin 3 more malleable. Preferably, fish skins 3 removed from the water bath are about 10 inches (25.4 centimeters) long and about 5 inches (12.7 centimeters) wide, though one skilled in the art will appreciate that other size fish skins 3 could be used in the pet chew.

Preferably, the fish skins 3 are from cod, pollack, or haddock, though other fish skins may be used. The fish skin 3 enhances palatability of the pet chew 1 or texture of the pet chew 1 or both. The fish skin 3 is not ground, but is preferably in whole form, so that it can be coupled with the piece of corium 2. Preferably the fish skin 3 is about ⅛-inch to about ¼-inch (3.17 to 6.35 millimeters) thick, and optimally, about ⅛-inch (3.17 millimeters) thick. Preferably, one side of the fish skin 3 is a scaled side 4 that helps scrape plaque and tarter from teeth, however, fish skin 3 without scales may be desirable in certain applications. The other side of the fish skin 3 is flesh and is more gelatinous than the scale side 4. Only a small percentage of gelatin in the fish skin 3 is needed, for example 10% of the composition by weight, to provide enough malleability for bending and forming the fish skin 3, adhering to the piece of corium 2, and making the pet chew 1. To facilitate the manufacturing process, the fish skin 3 has a moisture content preferably from about 65% to about 75%, and optimally, about 75% moisture.

Referring now to FIG. 1D, the piece of corium 2 and fish skin 3 are layered one on top of the other. In one embodiment, the first layer may be the piece of corium 2 that is placed on a surface. The fish skin 3 is then oriented with the piece of corium 2 and placed, scale side 4 facing up, on top of the piece of corium 2.

Referring to FIG. 1A, the layered piece of corium 2 and fish skin 3 may then be formed into rolls where the piece of corium 2 is the outside surface of the pet chew 1. Referring now to FIG. 2, in an alternative embodiment the first layer is fish skin 3 placed scale side 4 down on a surface. The piece of corium 2 is then oriented with the fish skin 3 and placed on top of the fish skin 3 so that the piece of corium 2 contacts the flesh side of the fish skin 3. The layered piece of corium 2 and fish skin 3 are rolled into pet chews 5 where the scaled side 4 of the fish skin 3 is the outside surface of the pet chew 5.

Rolled layers of pieces of corium 2 and fish skin 3 are then organized on racks and placed into a heated dehydration chamber for about 120 hours to about 144 hours, and optimally, about 120 hours at about 160° Fahrenheit to about 170° Fahrenheit (71.1° Celsius to 76.7° Celsius), and optimally, about 170° Fahrenheit (76.7° Celsius). When pieces of corium 2 or fish skin 3 are heated to over 170° Fahrenheit (76.7° Celsius) gelatin starts to form and acts as a layer of glue that adheres or couples the piece of corium 2 to the fish skin 3. Cooling the gelatin that formed during heating may set the piece of corium 2 and the fish skin 3 so that the pet chew product 1, 5 retains its shape. When the pet chews 1, 5 have reached the desired moisture content, preferably from about 7.0% to 8.25% moisture and optimally about 7.5% to about 8.0% moisture, they are removed from the dehydration chamber to cool. As the pet chew 1, 5 cools, the gelatin between the pieces of corium 2 and fish skin 3 layers hardens, increasing the durability of the pet chew 1, 5. After the pet chew 1, 5 cools, it is ready for packaging.

In pet chew 1, 5 the stacked layers may be formed into rolls that have a desired length and diameter. One skilled in the art will appreciate that two or three alternating layers of pieces of corium 2 and fish skin 3 are preferred, however, the pet chew 1, 5 may have more layers, for example seven or eight alternating layers of pieces of corium 2 and fish skin 3.

Referring now to FIG. 3, the piece of corium 2 may be rolled into a corium core 6 having a desired shape. Preferably, the rolled corium core 6 has a cylindrical shape, though triangular, square, or other shapes may be desired. The corium 2 could also be rolled into a hollow or solid shape. The rolled corium core 6 is placed on a rack and moved into a heated dehydration chamber for about 72 hours to about 84 hours, and optimally, about 72 hours. The temperature of the dehydration chamber is maintained at about 160° Fahrenheit to about 170° Fahrenheit (71.1° Celsius to 76.7° Celsius), and optimally, about 170° Fahrenheit (76.7° Celsius) until the rolled corium core 6 reaches the desired moisture content, preferably from about 7.0% to 8.25% and optimally about 7.5% to about 8% moisture. The dehydrated rolled corium core 6 is extremely durable when dry. As the dog begins to chew the rolled corium core 6, their saliva starts to soften the corium 2. The junction of the soft salvia-soaked corium and the dry corium creates a very effective plaque removal tool for the pet owner who does not want to or cannot brush their dog's teeth.

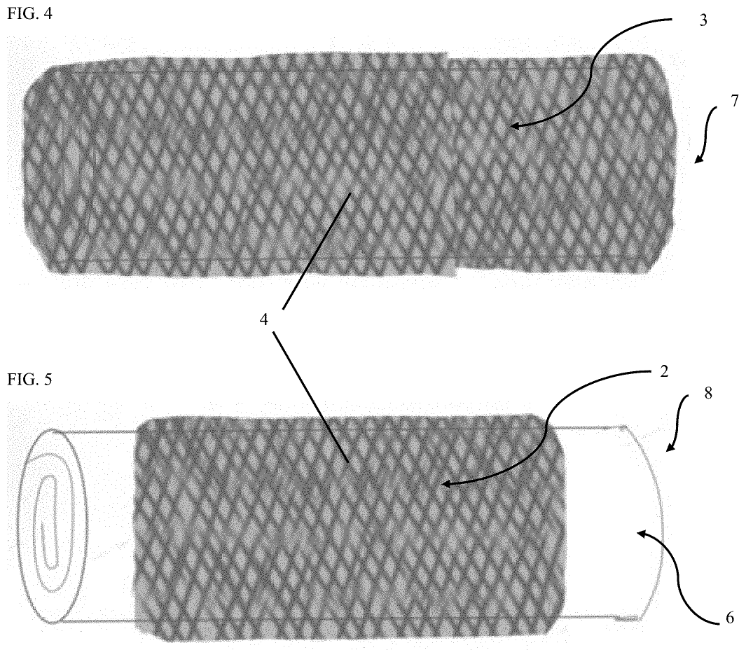

Referring now to FIG. 4, the dehydrated rolled corium core 6 is wrapped with malleable fish skin 3. Preferably the fish skin 3 is wrapped, scale side 4 out, around the rolled corium core 6. The flesh side of the fish skin 3, having more gelatin than the scale side 4, naturally adheres to the rolled corium core 6. It is therefore preferable to have the flesh side of the fish skin 3 contact the rolled corium core 6. It will be appreciated that the fish skin 3 can fully wrap and encapsulate the rolled corium core 6 as shown in FIG. 4.

Referring now to FIG. 5, in another embodiment the pet chew 8 may have the rolled corium core 6 that is partially wrapped by the fish skin 3, scale side 4 out. The fish skin 3 wrapped corium core 6 pet chews 7, 8 are then organized on racks and placed into a heated dehydration chamber for about 2.5 hours to about 4 hours, and optimally, about 3.5 hours at about 160° Fahrenheit to about 170° Fahrenheit (71.1° Celsius to 76.7° Celsius), and optimally, about 170° Fahrenheit (76.7° Celsius).

When the rolled corium core 6 is wrapped with fish skin 3, scale side 4 out, the fish skin 3 wrapper does not come off the rolled corium core 6 due to natural gelatinous adhesive in the fish skin 3 and corium 2 until the dog chews it off piece by piece. The extends chew time of the pet chew 7 and prevents whole piece consumption of the fish skin 3.

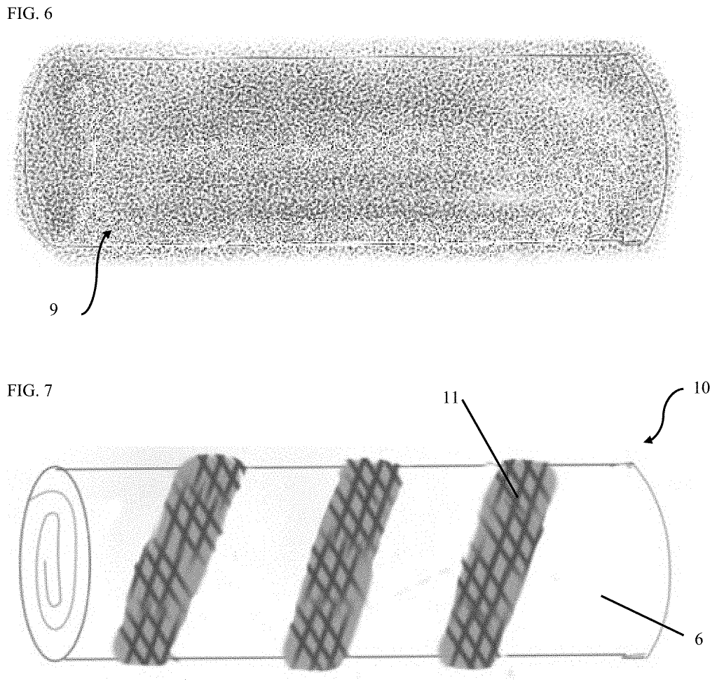

Referring now to FIG. 6, shown generally is an extruded corium core 9. To form the extruded core 9, fresh or preserved beef corium is first ground into the desired particle size, preferably from 1/10 inch (3 millimeters) to about ⅕ inch (5 millimeters), and optimally, about 4/25 inch (4 millimeters). Because the beef corium is granulated it is less durable than whole beef corium. One skilled in the art will appreciate that granulated beef corium cores 9 are more digestible because of the increased surfaces area of the particles and easier for teething puppies and older dogs with teeth issues to chew.

Additives may be mixed into the granulated beef corium to further improve palatability, increase the nutritional value, or for marketing purposes. For example, a coloring agent or dye may be added. For example, green and red dyes are popular additives in pet treats and chews during the holidays. Another additive may be flavoring. Various flavorings can be used such as cheese, milk powder, and peanut butter. Animal meat, such as chicken, beef, lamb or pork, can also be used as a flavoring. Natural flavors, phytonutrients, and nutraceuticals may be added to the granulated corium. For example, turmeric, powered pumpkin, dried coconut water, powdered avocado, or dried beet root could be added.

The mixture of granulated corium may be extruded through a die plate. In the illustrated example, the extruded corium core 9 is in the shape of a cylindrical rod. One skilled in the art will appreciate that other cross-section designs, such as a star, or square, may be implemented as desired. The extruded core could also have a solid or hollow cross-section. The extruded corium core may be seamless, due to the extrusion process. The extruded corium core 9 may be cut to a length extending between two ends. For example, the extruded corium core 9 may be cut to a length from between 2 inches to 30 inches (5.08 to 76.2 centimeters). The granulated corium may also be extruded into sheets that are formed or rolled or into a desired shape like a cylinder for example, as illustrated in FIG. 6. The extruded corium may also be formed into other shapes like an oval, heart, fish, snowman.

The extruded corium core 9 has a thickness that is consistent along the length. Preferably, the outside diameter of the extruded corium core 9 is between ½ inch to 2½ inches (1.27 centimeters to 6.35 centimeters). In general, the larger the pet chew, the thicker the extruded corium core 9 diameter to maintain structural integrity of the product before being given to a dog to chew.

The extruded corium core 9 is placed on a rack and into a heated dehydration chamber for about 72 hours to about 84 hours, and optimally, about 72 hours. The dehydration chamber maintains a constant temperature of about 160° Fahrenheit to about 170° Fahrenheit (71.1° Celsius to 76.7° Celsius), and optimally, about 170° Fahrenheit (76.7° Celsius) until a desired moisture level has been reached. The desired moisture content of the extruded corium core 9 is preferably from about 7.0% moisture to about 8.0% moisture and optimally, about 7.5% moisture. After the desired moisture content is reached, the extruded corium core 9 naturally has a rough, bumpy exterior texture that further improves the mechanical scraping and plaque removal properties of the pet chew. When the extruded corium core 9 becomes wet, however, the gelatin adhesive bond that holds the corium granules together breaks down, reducing the extruded corium core 9 durability by about 50% compared to other corium cores, for example the rolled corium core 6. While the extruded corium core 9 is not as durable as the rolled corium core 6, the extruded corium core 9 is more digestible because of the increased surface area and is easier to chew.

After the extruded corium core 9 is at the desired moisture level, it is wrapped with a layer or strip of malleable fish skin 3, scale side 4 out. The flesh side, having more gelatin than the scale side 4, naturally adheres to the extruded corium core 9, accordingly it is preferable to have the flesh side of the fish skin contact the extruded corium core 9. It will be appreciated that the fish skin 3 can fully wrap and encapsulate the extruded corium core 9 or the fish skin 3 can partially wrap the extruded corium core 9. These fish skin 3 wrapped extruded corium cores 9 are then organized on racks and placed into a heated dehydration chamber for about 2.5 hours to about 4 hours, and optimally, about 3.5 hours at about 160° Fahrenheit to about 170° Fahrenheit (71.1° Celsius to 76.7° Celsius), and optimally, about 170° Fahrenheit (76.7° Celsius), until the extruded corium core 9 and the fish skin 3 become gelatinous and adhere to each other.

Referring now to FIG. 7, shown generally is a pet chew 10 having a rolled or twisted strip of fish skin 11, preferably in a desirable rope shape, strung around a rolled corium core 6. It will be appreciated that an extruded corium core 9 could alternatively be used in pet chew 10. The fish skin rope 11 can be a different color than the rolled corium core 6 for visual contrast. The fish skin rope 11 can be an outer wrap that is wrapped in a spiral, as shown, for example, in FIG. 7. With such a spiral wrap, portions of the rolled corium core 6 are visible. Alternatively, the fish skin rope 9 can wrap around substantially most of the rolled corium core 6, from one end to the other of the pet chew 10.

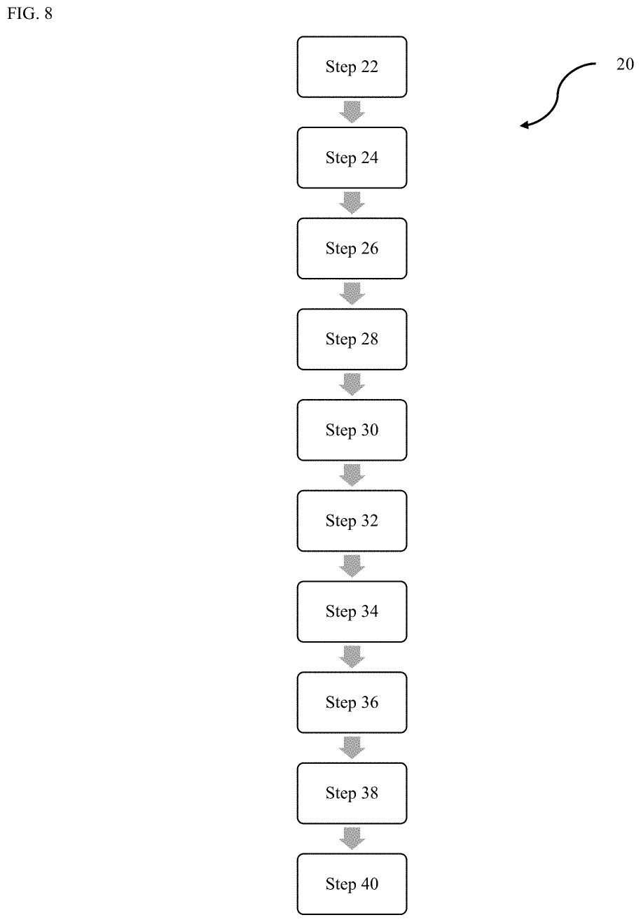

FIG. 8 provides a flowchart 20 directed to the preferred manufacturing process of a pet chew, an example of which is described below. According to the methods of manufacturing an embodiment of the invention, the pet chew is processed by a number of steps. These steps are merely exemplary of the order these steps may occur. The steps may occur in any order that is desired such that it still results in the manufacture of an embodiment of the invention.

Step 22: Prepare the corium. The corium is rinsed in a mixture of hydrogen peroxide and water.

Step 24: Cut the malleable beef corium to a desired shape. The corium may be cut using an utility knife, a rotary cutter, or scissors. Automatic cutting machines can alternatively be used to cut the corium. Preferably, the corium is cut to generally about 7 inches (17.78 centimeters) long and generally about 11 inches (27.94 centimeters) wide and preferably a rectangular shape that is 8 inches (20.32 centimeters) long and 10 inches (25.4 centimeters) wide. Preferably the corium is about ⅛-inch to about ⅜-inch (3.17 to 9.5 millimeters) thick, and optimally, about ¼ inch (6.35 millimeters) thick.

Step 26: Prepare the fish skin. Soak the fish skin in a water bath that is between about 80° Fahrenheit and about 95° Fahrenheit (26.67° to 35° Celsius), preferably about 85° Fahrenheit (29.44° Celsius). When the fish skin is between 35° Fahrenheit and 50° Fahrenheit (1.67° to 10° Celsius), preferably about 45° Fahrenheit (7.22° Celsius) it is removed from the water bath.

Step 28: Check the fish skin. After removal from the water bath, the fish skin moisture content is preferably from about 65% to about 75% moisture. Optimally, after removal from the water bath the fish skin will have a moisture content of about 75% moisture.

Step 30: Place the cut corium on a surface. Preferably, the cut corium is arranged flat so that no part of the cut corium placed on the surface overlaps itself.

Step 32: Stack layers of corium and fish skin. Orient the fish skin over the corium and place the fish skin on top of the corium, scale side facing up, creating stacked layers. To thicken or change the shape of the pet chew, additional layers of corium and fish skin can be added to the stack.

Step 34: Shape the stacked layers of the corium and fish skin. The stacked layers of corium and fish skin are rolled into a desired shape, preferably a cylinder. Preferably, the lowest layer of the stack creates the outer surface of the roll.

Step 36: Organize the rolls on racks.

Step 38: Heat and dehydrate the rolls. Place the rolls loaded on racks into a heated dehydration chamber for about 2.5 hours to about 4 hours, and optimally, about 3.5 hours at about 160° Fahrenheit to about 170° Fahrenheit (71.1° Celsius to 76.7° Celsius), and optimally, about 170° Fahrenheit (76.7° Celsius) until the layers of corium and fish skin become gelatinized and adhere to each other.

Step 40: Remove the rolls from the dehydration chamber after moisture in the pet chew is reduced to preferably about 7.0% to 8.25% moisture and optimally about 7.5% to about 8.0% moisture.

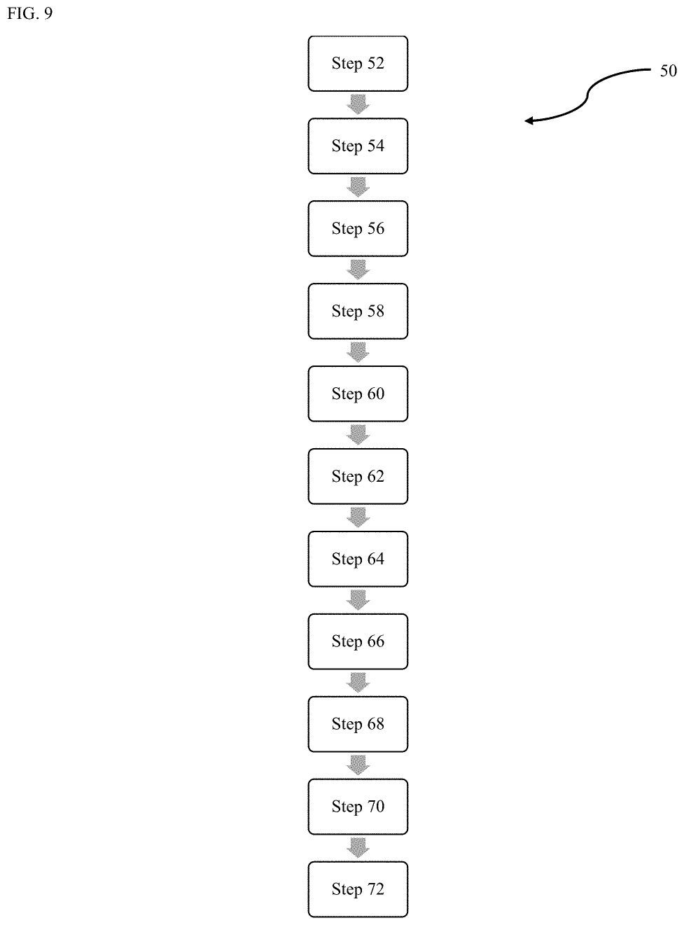

FIG. 9 provides a flowchart 50 directed to the preferred manufacturing process of a pet chew, an example of which is described below. According to the methods of manufacturing an embodiment of the invention, the pet chew is processed by a number of steps. These steps are merely exemplary of the order these steps may occur. The steps may occur in any order that is desired such that it still results in the manufacture of an embodiment of the invention.

Step 52: Prepare corium. Grind corium into desired particle sizes, preferably from 1/10 inch (3 millimeters) to about ⅕ inch (5 millimeters), and optimally, about 4/25 inch (4 millimeters).

Step 54: Load the granulated corium into an extrusion machine.

Step 56: Extrude the granulated corium through a die plate.

Step 58: Cut the extruded corium to a length extending between two ends, preferably a length between 2 inches to 30 inches (5.08 to 76.2 centimeters).

Step 60: Heat and dehydrate the extruded corium. Place the cut extruded corium on racks in a heated dehydration chamber for about 72 hours to about 84 hours, and optimally, about 72 hours. The dehydration chamber maintains a constant temperature of about 160° Fahrenheit to about 170° Fahrenheit (71.1° Celsius to 76.7° Celsius), and optimally, about 170° Fahrenheit (76.7° Celsius) until the desired moisture level has been reached.

Step 62: Remove the extruded corium from the dehydration chamber when the moisture content of the corium core is preferably from about 7.0% moisture to about 8.0% moisture and optimally, about 7.5% moisture.

Step 64: Soak the fish skin in a water bath that is between about 80° Fahrenheit and about 95° Fahrenheit (26.67° to 35° Celsius), preferably about 85° Fahrenheit (29.44° Celsius). When the fish skin is between 35° Fahrenheit and 50° Fahrenheit (1.67° to 10° Celsius), preferably about 45° Fahrenheit (7.22° Celsius) it is removed from the water bath.

Step 66: Check the fish skin. After removal from the water bath, the fish skin moisture content is preferably from about 65% to about 75% moisture. Optimally, after removal from the water bath the fish skin will have a moisture content of about 75% moisture.

Step 68: Wrap the extruded corium with fish skin. Place the washed fish skin on a surface. Preferably, the fish skin is arranged flat, scale side down, so that no part of the fish skin placed on the surface overlaps itself. Orient the extruded corium over the fish skin and place the extruded corium on top of the fish skin. Wrap the fish skin around the extruded corium. To thicken or change the shape of the pet chew, additional pieces of fish skin can be wrapped around the extruded corium.

Step 70: Organized the fish skin wrapped extruded corium on racks in a heated dehydration chamber for about 2.5 hours to about 4 hours, and optimally, about 3.5 hours at about 160° Fahrenheit to about 170° Fahrenheit (71.1° Celsius to 76.7° Celsius), and optimally, about 170° Fahrenheit (76.7° Celsius)

Step 72: Remove the fish skin wrapped extruded corium from the dehydration chamber when the moisture content is preferably about 7.0% to 8.25% moisture and optimally about 7.50% to about 8.0% moisture.

The manufacturing processes described above are exemplary, and various alternative techniques can be practiced to construct the edible pet chew. For example, automated extrusion methods can be employed to mass produce corium cores, or mechanical wrapping devices can be employed to wrap the fish skin around the corium.

Although the present invention has been described in terms of various embodiments, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

1. An edible pet chew, comprising:
a first component comprising at least one malleable fish skin that has been prepared by soaking in 80°-95° Fahrenheit (26.67°-35° Celsius) water, the fish skin having an inner surface with a first gelatin adhesive and an outer surface having scales;
a second component comprising beef corium having a second gelatin adhesive; and
wherein the first component is coupled to the second component by the first and second gelatin adhesives.

2. The edible pet chew as defined in claim 1 wherein a moisture content of the first component is 65% to 75% moisture.

3. The edible pet chew as defined in claim 1 wherein a moisture content of the second component is 73% to 77% moisture.

4. The edible pet chew as defined in claim 1 wherein a moisture content of the edible pet chew is between 7.0%— 8.25% moisture.

5. The edible pet chew as defined in claim 1 wherein a dry weight ratio of the edible pet chew is between about 75% to 80% first component and about 20% to 25% second component.

6. The edible pet chew as defined in claim 1 wherein the first component is helically wrapped around the second component.

7. The edible pet chew as defined in claim 1 wherein the first component partially wraps around the second component.

8. The edible pet chew as defined in claim 1 wherein the first component encapsulates the second component.

9. The edible pet chew as defined in claim 1 wherein the first component is coupled to the second component after being heated for 120 hours at about 160°-170° Fahrenheit (71.1°-76.7° Celsius), and optimally, about 170° Fahrenheit (76.7° Celsius).

10. An edible dog chew, comprising:
a core made of beef corium, an outer surface of the core having a first texture;
a wrap made of fish skin having a first surface with a gelatinous adhesive and a second surface having a second texture, the first surface in contact with the outer surface of the core; and
wherein the first surface of the wrap adhered to the outer surface of the core.

11. The edible dog chew as defined in claim 10 wherein the wrap and the core are heated for about 2.5 to 4 hours, and optimally, about 3.5 hours at about 160° to 170° Fahrenheit (71.1° to 76.7° Celsius).

12. The edible dog chew as defined in claim 10 wherein the core is an extruded beef corium.

13. The edible dog chew as defined in claim 10 wherein the core is a rolled piece of beef corium having a cylindrical shape.

14. The edible dog chew as defined in claim 10 wherein the second surface has scales.

15. The edible dog chew as defined in claim 10 wherein the gelatinous adhesive is between 7.5%-8.0% moisture.

16. An edible dog chew, comprising
at least one beef corium laver:
at least one fish skin layer adjacent the beef corium layer, the fish skin layer having a scaled surface oriented away from the beef corium laver and a gelatinous surface oriented toward the beef corium laver;
wherein the fish skin layer and beef corium layer are formed together into a stack dimensioned large enough and thin enough to be malleable for flexing, folding, or rolling into a first shape; and
wherein the stacked layers are flexed, folded or rolled into the first shape before hardening into a final shape.

17. An edible dog chew as defined in claim 16 wherein the final shape is a cylinder.

18. An edible dog chew as defined in claim 16 wherein a moisture content of the final shape is between 7.5%— 8.0% moisture.

19. An edible dog chew as defined in claim 16 wherein the first shape is heated for about 3.5 hours at about 160°-170° Fahrenheit (71.1°-76.7° Celsius), and optimally, about 170° Fahrenheit (76.7° Celsius).

20. A method of forming an edible pet chew, said method comprising:
processing a beef corium into a particle size of about 3 mm to about 5 mm to form a mixture;
molding the mixture into a desired three-dimensional core;
dehydrating the core until a moisture level of about 7.5% to about 8.0% moisture has been reached;
preparing a fish skin by soaking the fish skin in 80°-95° Fahrenheit (26.67°-35° Celsius) water, the fish skin having a moisture content of about 65% to about 75% moisture;
wrapping the fish skin around the core such that a portion of the core remains exposed; and
dehydrating the wrapped core until the desired moisture level has been reached.
